(19) United States
(12) Patent Application Publication
(10) Pub. No.: US 2015/0037155 A1
(43) Pub. Date: Feb. 5, 2015

(54) FAN ROTOR PILOTING

(71) Applicant: Hamilton Sundstrand Corporation, Windsro Locks, CT (US)

(72) Inventors: Craig M. Beers, Wethersfield, CT (US); Darryl A. Colson, West Suffield, CT (US)

(73) Assignee: Hamilton Sundstrand Corporation, Windsor Locks, CT (US)

(21) Appl. No.: 13/956,455

(22) Filed: Aug. 1, 2013

(51) Int. Cl. B64D 13/00; F04D 29/26

(52) U.S. Cl. CPC B64D 13/00; F04D 29/26
USPC 416/182

(57) ABSTRACT

A fan rotor has a plurality of blades arranged circumferentially about a central axis, wherein the plurality of blades extend between 2.9980 and 3.0020 inches radially from the central axis. The fan rotor has a root portion arranged radially inward from the plurality of blades. The fan rotor also has a web portion that connects the plurality of blades to the root portion, the web portion having a minimum longitudinal thickness between 0.2000 and 0.2100 inches.

### BACKGROUND

The present invention relates to Air Cycle Machines (ACM), such as the type used in Environmental Control Systems in aircraft.

ACMs may be used to compress air in a compressor section. The compressed air is discharged to a downstream heat exchanger and further routed to a turbine. The turbine extracts energy from the expanded air to drive the compressor. The air output from the turbine may be utilized as an air supply for a vehicle, such as the cabin of an aircraft.

ACMs often have a three-wheel or four-wheel configuration. In a three-wheel ACM, a turbine drives both a compressor and a fan which rotate on a common shaft. In a four-wheel ACM, two turbine sections drive a compressor and a fan on a common shaft.

Airflow is directed into the fan section, and separately to the compressor section. From the compressor section, air is routed towards the heat exchanger, from the heat exchanger to the turbine or turbines, and from the final turbine stage out of the ACM. In at least some of these transfers, it is desirable to direct air radially with respect to the central axis of the ACM. To accomplish this, rotating nozzles may be used to generate radial in-flow and/or out-flow.

The dimensions of each component of air cycle machines are interrelated to form the various seals and clearances between moving parts that keep the air cycle machine operating properly. In particular, the fan rotor of an air cycle machine must be designed such that it is capable of rotating about the central axis of the air cycle machine without moving longitudinally. Furthermore, the dimensions of the fan rotor must be configured such that the fan rotor is structurally sound during rapid rotation.

### SUMMARY

The housing component of a fan and compressor section of an air cycle machine includes a main bore housing portion having an inner radius between 1.9400 and 1.9440 inches, a static seal portion having an inner radius between 2.0420 and 2.0440 inches, a shroud pilot housing portion having an inner radius between 5.9440 and 5.9470 inches, and an insulator seal plate housing portion having an inner radius between 8.6380 and 8.6420 inches.

### BRIEF DESCRIPTION OF THE DRAWINGS

FIG. 1 is a cross-sectional view of an air cycle machine.

FIG. 2 is a cross-sectional view of a fan rotor according to an embodiment of the present invention.

FIG. 3 is a cross-sectional view of a fan rotor according to the embodiment of the present invention.

### DETAILED DESCRIPTION

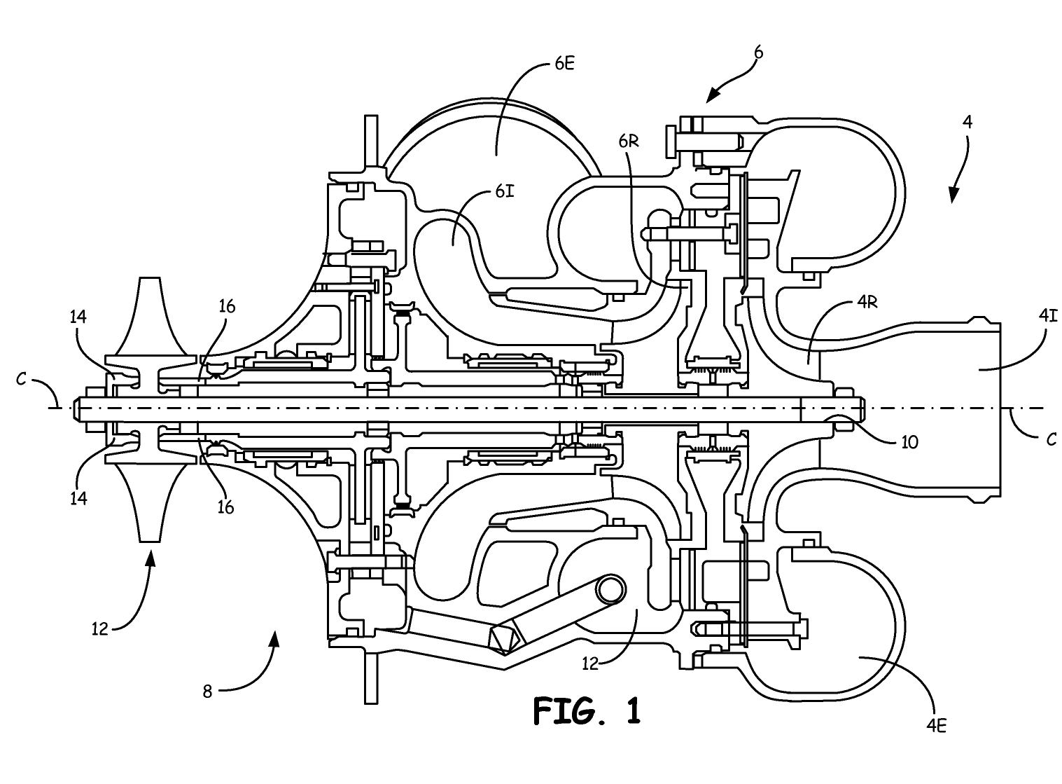

FIG. 1 is a cross-sectional view of three-wheel Air Cycle Machine (ACM) 2. ACM 2 is a device that may be used in the environmental control systems of an associated aircraft (not shown). ACM 2 may be a part of an associated gas turbine engine (not shown).

ACM 2 includes several stages, including compressor stage 4, turbine stage 6, and fan stage 8. ACM 2 further includes tie rod 10. Compressor stage 4 includes compressor inlet 4I, compressor exit 4E, and compressor rotor 4R. Turbine stage 6 includes turbine inlet 61, turbine exit 6E, and turbine rotor 6R. Fan stage 8 includes fan rotor 12, fan ring 14, and thrust shaft 16. Compressor rotor 4R, turbine 6R, tie rod 10, and fan rotor 12 co-rotate about a common center line C and, in combination, form a single spool.

Compressor stage 4 converts and transfers rotational energy to its working fluid by pressurizing it. Compressor stage 4 is a structure through which a working fluid may be routed. Compressor rotor 4R is mechanically driven by tie rod 10, and is used to compress and/or heat working fluid that passes through it. Compressor stage 4 includes a housing that contains the working fluid, including compressor inlet 4I and compressor exit 4E.

Turbine stage 6 is a structure through which a working fluid is routed. Turbine rotor 6R is used to extract energy from the working fluid that passes through it to drive rotation of turbine stage 6 and connected components, leaving the working fluid with lower temperature and/or lower velocity. In other embodiments, the working fluid routed through turbine stage 6 may be in fluid communication with the working fluid that passes through compressor stage 4. Turbine stage 6 includes a housing that contains the working fluid, including turbine inlet 6I and turbine exit 6E.

Turbine stage 6 extracts potential energy from working fluid passing therein, which it converts to rotational energy that is transferred to tie rod 10. Working fluid enters turbine stage 6 at turbine inlet 6I, drives turbine rotor 6R, and exits turbine stage 6 via turbine exit 6E. Turbine stage 6 extracts thermal and kinetic energy from working fluid therein by using the working fluid to drive turbine rotor 6R. Thus, working fluid exiting at turbine exit 6E is at lower pressure and/or lower velocity than fluid entering turbine stage 6 at turbine inlet 6I. One common source of working fluid that is routed through turbine stage 6 is a heat exchanger, such as one to which compressed fluid was delivered by compressor stage 4.

Fan stage 8 may be used to move a working fluid. For example, fan stage 8 is used to propel ram air from an associated gas turbine engine to a desired location. Fan stage 8 includes fan rotor 12, fan ring 14, and thrust shaft 16. Fan stage 8 is typically used to draw ram air from an associated gas turbine engine. For example, fan stage 8 may be used to draw ram air through a heat exchanger (not shown).

Tie rod 10 is an elongated rod along centerline C. Tie rod 10 supports the shear stresses associated with connecting various components of ACM 2 that apply opposite angular forces.

Each of compressor stage 4, turbine stage 6, and fan stage 8 are positioned around and connected to tie rod 10 to form one interconnected spool. Compressor stage 4 is adjacent to turbine stage 6, and fan stage 8 is adjacent to turbine stage 6.

Working fluid is routed to compressor stage 4 at compressor inlet 4I and compressed via compressor rotor 4R. As tie rod 10 is rotated by turbine stage 6, compressor rotor 4R also rotates, causing compression of working fluid within compressor stage 4. Thus, compressor rotor 4R is used to translate rotational energy of a spool of components attached to tie rod 10 into potential energy the working fluid passing therethrough, by increasing the pressure and/or temperature of such working fluid. Compressed working fluid exits compressor stage 4 at compressor exit 4E. From compressor exit 4E, the working fluid may pass to a variety of other components. Typically, these components are used to condition the compressed working fluid for use in the environmental control systems of an associated aircraft. Accordingly, one common destination for the compressed working fluid from compressor exit 4E is a heat exchanger, which may be used to cool the compressed working fluid to a desired temperature.

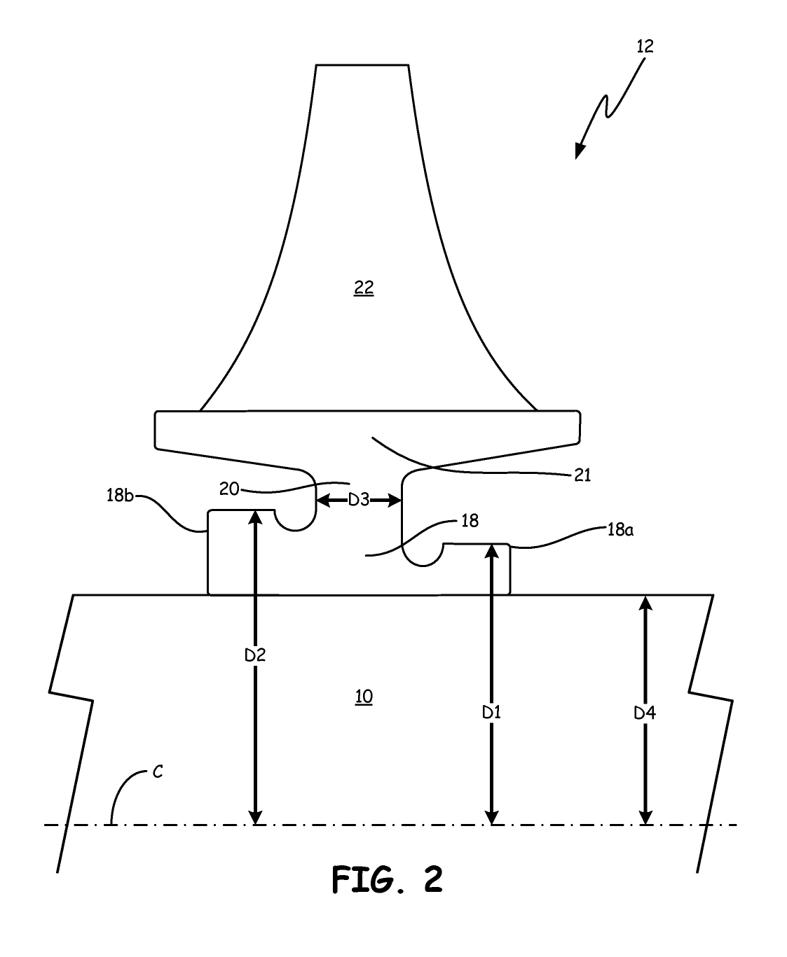

Fan stage 8 is positioned adjacent to turbine stage 6, and includes fan rotor 12, which is secured between tie rod 10, fan ring 14, and thrust shaft 16. Fan rotor 12 abuts tie rod 10 with sufficient clearance that fan rotor 12 can rotate about tie rod 10. Fan rotor 12 is secured against movement along tie rod 10 in one direction by fan ring 14. Fan rotor 12 is secured against movement along tie rod 10 in the opposite direction by thrust shaft 16. Fan rotor 12 co-rotates with tie rod 10, such that fan rotor 12 draws air, as is described in more detail with respect to FIG. 2. Typically, the working fluid that passes through fan stage 8 is not in fluid communication with the working fluid passing through either compressor stage 4 or turbine stage 6. In some cases, the air routed through a shroud of fan section 8 is routed to a heat exchanger (not shown).

Fan stage 8 uses rotational energy to pull air from one location to another. Fan stage 8 includes fan rotor 12, which is connected to tie rod 10 such that fan rotor 12 rotates with tie rod 10. The air pulled by fan rotor 12 is typically not in fluid communication with the working fluid of compressor stage 4 or turbine stage 6. In some embodiments, fan stage 8 pulls ram air through a heat exchanger, such as a heat exchanger through which working fluid is routed between compressor exit 4E and turbine inlet 6I.

By transferring heat between these two fluids, air may be taken from the bleed system of a gas turbine engine and its properties modified by the compressor, turbine, and heat exchanger such that it is suitable for use in the environmental control system of an aircraft.

In alternative embodiments, ACM 2 could be a four-wheel air cycle machine rather than the three-wheel air cycle machine shown in FIG. 1. Additionally, components such as a diffuser, may be incorporated into ACM 2.

FIG. 2 is a cross-sectional view of fan rotor 12. As previously illustrated with respect to FIG. 1, fan rotor 12 is a part of fan stage 4 of ACM 2.

Fan rotor 12 comprises root portion 18, web portion 20, pilot fillet area 21, and blade portion 22. Fan rotor 12 is integrally formed, as by casting, molding, additive manufacturing, or any other known process. Root portion 18 is configured for interfacing with tie rod 10, as illustrated in FIG. 1. Root portion includes first foot 18a and a second foot 18b, which extend longitudinally along the central axis about which fan rotor 12 and tie rod 10 rotate.

Fan rotor 12 has specific dimensions that is compact in dimensional size, and minimizes its own weight. An optimized pilot for a rotor generates both rotor hub and mating shaft geometry which is the most compact in dimensional size and also with the least amount of weight generated. This minimizes aircraft weight as both the fan rotor and the surrounding containment structure size are as light as functionally possible. Minimized weight improves overall aircraft performance and fuel efficiency.

First foot outer radius D1 illustrates the distance between centerline C and the outer radial face of first foot 18a. First foot radius D1 is between 1.379 and 1.380 cm (0.5430 and 0.5434 in.). More preferably, first foot radius D1 may be between 1.3795-1.3800 cm (0.5431-0.5433 in.). Second foot radius D2 illustrates the distance between centerline C and the outer radial face of second foot 18b. Second foot radius D2 is between 1.4173 and 1.4183 cm (0.5580 and 0.5584 in.). More preferably, second foot radius D2 may be between 1.4176-1.4181 cm (0.5581-0.5583 in.). Web width D3 is the minimum width of blade portion 22 at its narrowest point. Web width D3 is between 0.5080 and 0.5334 cm (0.2000 and 0.2100 in.). More preferably, web width D3 may be between 0.5156-0.5258 (0.203-0.207 in.). Inner surface radius D4 illustrates the inner radius of root portion 18, where it intersects with tie rod 10. Inner surface radius D4 is between 0.6896 and 0.6922 cm (0.2715 and 0.2725 in.). More preferably, inner surface radius D4 is between 0.6904-0.6914 cm (0.2718-0.2722 in.).

Root portion 18 is annular in shape, and tie rod 10 is cylindrical, such that tie rod 10 and root portion 18 have a shared interface. Typically, tie rod 10 is connected to root portion 18 by an interference fit. Root portion 18 is connected to web portion 20, and an undercut radius is included in root portion 18 to prevent accumulation of stresses between root portion 18 and web portion 20. Web portion 20 extends radially outwards from root portion 18 between first foot 18a and second foot 18b. Pilot fillet area 21 extends radially outward from centerline C from web 20. Pilot fillet area 21 is axially longer than web 20, and supports blade portion 22. Blade portion 22 extends radially outwards from pilot fillet area 21.

First foot 18a is positioned between tie rod 10 and thrust shaft 16, whereas second foot 18b is positioned between tie rod 10 and fan ring 14. Pilot fillet area 21 connects web 20, and indirectly connects root 18 and tie rod 10, to blade portion 22. Blade portion is a portion of fan rotor 12 that acts upon a working fluid, such as ram air from a gas turbine engine. Fan rotor 12 may rotate rapidly due to the rotation of tie rod 10, as described with respect to FIG. 1. As blade portion 22 rotates, it may impart significant forces to push fan rotor 12 along the length of tie rod 10. Thus, fan ring 14 and thrust shaft 16 are positioned such that they abut web portion 20 and prevent such longitudinal displacement.

The particular dimensions of first foot radius D1, second foot radius D2, web width D3, and inner surface radius D4 are optimized. Optimization of the dimensions of root 18 generates hub geometry which is the most compact in dimensional size and also with the least amount of weight generated. This minimizes aircraft weight as both the fan rotor and the surrounding containment structure size are as light as functionally possible. Minimized weight improves overall aircraft performance and fuel efficiency.

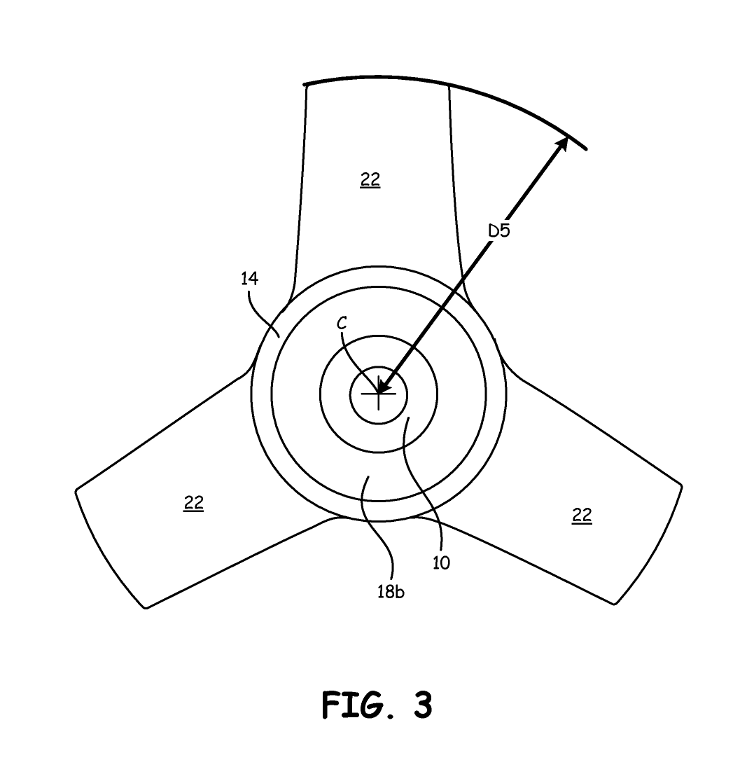

FIG. 3 shows a cross-sectional view of fan rotor 12 arranged about tie rod 10. Fan ring 14 is shown circumscribing second foot 18b of root portion 18, which in turn circumscribes tie rod 10. Blade portion 22 extends radially outward from root portion 18. The maximum radial distance from centerline C which blade portion 22 extends is illustrated as blade length D5. Blade length D5 is between 7.6149 and 7.6251 cm (2.9980 and 3.0020 in.). More preferably, blade length D5 may be between 7.6175-7.6225 cm (2.9990-3.0010 in).

As described above, a blade length in the specified ranges presents advantages for use in an ACM such as ACM 2. Optimization of blade length D5 provides advantages such as maximized aircraft cabin heat removal and minimized noise from ram circuit, while minimizing energy used from aircraft engines, auxiliary power units, ground carts, generators, and other similar sources of energy. It also minimizes the weight of ACM 2, due to reductions in weight of both fan rotor 12 and the surrounding containment structure (not shown). Minimized weight improves overall aircraft performance and fuel efficiency.

### Discussion of Possible Embodiments

The following are non-exclusive descriptions of possible embodiments of the present invention.

A fan rotor includes a plurality of blades arranged circumferentially about a central axis. The plurality of blades extend between 7.6149 and 7.6251 centimeters radially from the central axis. A root portion is arranged radially inward from the plurality of blades. A web portion connects the plurality of blades to the root portion. The web portion has a minimum longitudinal thickness between 0.5080 and 0.5334 centimeters.

The root portion may define an inner surface circumscribing the central axis, the inner surface having a diameter between 0.6896 and 0.6922 centimeters. More narrowly, the diameter of the inner surface may be between 0.6904 and 0.6914 centimeters. The root portion may include a first foot extending in a first longitudinal direction from the web portion. Such first foot may include an annular structure having an outer diameter between 1.379 and 1.380 centimeters. More narrowly, the outer diameter of the first foot may be between 1.3795 cm and 1.3800 cm. The root portion may include a second foot portion extending in a second longitudinal direction from the web portion. Such second longitudinal direction is opposite the first longitudinal direction. The second foot portion may be an annular structure having an outer diameter between 1.4173 and 1.4183 centimeters. More narrowly, the outer diameter of the second foot portion may be between 1.4176 and 1.4181 centimeters. The web width may be between 0.5156 cm and 0.5258 cm. The blades may extend between 7.6175 and 7.6225 centimeters radially from the central axis. The fan rotor may also include an undercut radius at both the intersection of the web portion and the first foot portion, and at the intersection of the web portion and the second foot portion.

An air bearing air cycle machine includes a tie rod arranged about a central axis and a fan rotor. The fan rotor includes a root portion arranged radially around the tie rod and having an inner radius between 0.6896 and 0.6922 centimeters. The root portion includes a first foot portion, which is an annular structure extending longitudinally in a first longitudinal direction from the web portion. The root portion also includes a second foot portion, which is an annular structure extending longitudinally in a second longitudinal direction from the web portion, opposite the first longitudinal direction. A web portion extends radially from the root portion, and has a minimum longitudinal thickness between 0.5080 and 0.5334 centimeters. A blade portion extends radially from the web portion. A fan ring is arranged radially outward of the first foot portion, and a seal shaft is arranged radially outward of the second portion.

The inner radius may be between 0.6904 and 0.6914 centimeters. The minimum longitudinal thickness of the web portion may be between 0.5156 and 0.5258 centimeters. The blade portion may extend from the web portion by a blade length between 7.6149 and 7.6251 centimeters. The blade length may, more narrowly, be between 7.6175 and 7.6225 centimeters. The first foot portion may extend from the central axis by a first foot radius, wherein the first foot radius is between 1.379 and 1.380 centimeters, or more narrowly between 1.3795 and 1.3800 centimeters. The second foot portion may extend from the central axis by a second foot radius of between 1.4173 and 1.4183 centimeters. The second foot radius may, more narrowly, be between 1.4176 and 1.4181 centimeters. The root portion may further include a first radiused undercut defined between the first foot portion and the web portion and a second radiused undercut defined between the second foot portion and the web portion.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fan rotor comprising:
a plurality of blades arranged circumferentially about a central axis, wherein the plurality of blades extend between 7.6149 and 7.6251 centimeters radially from the central axis;
a root portion arranged radially inward from the plurality of blades; and
a web portion that connects the plurality of blades to the root portion, the web portion having a minimum longitudinal thickness between 0.5080 and 0.5334 centimeters.

2. The fan rotor of claim 1, wherein the root portion defines an inner surface circumscribing the central axis, the inner surface having a diameter between 0.6896 and 0.6922 centimeters.

3. The fan rotor of claim 2, wherein the diameter of the inner surface is between 0.6904 and 0.6914 centimeters.

4. The fan rotor of claim 1, wherein the root portion comprises a first foot extending in a first longitudinal direction from the web portion, the first foot comprising an annular structure having an outer diameter between 1.379 and 1.380 centimeters.

5. The fan rotor of claim 4, wherein the outer diameter of the first foot is between 1.3795 cm and 1.3800 cm.

6. The fan rotor of claim 4, wherein the root portion comprises a second foot portion extending in a second longitudinal direction from the web portion, wherein:
the second longitudinal direction is opposite the first longitudinal direction; and
the second foot portion comprises an annular structure having an outer diameter between 1.4173 and 1.4183 centimeters.

7. The fan rotor of claim 6, wherein the outer diameter of the second foot portion is between 1.4176 and 1.4181 centimeters.

8. The fan rotor of claim 1, wherein the web width is between 0.5156 cm and 0.5258 cm.

9. The fan rotor of claim 1, wherein the blades extend between 7.6175 and 7.6225 centimeters radially from the central axis.

10. The fan rotor of claim 4, and further comprising:
an undercut radius at the intersection of the web portion and the first foot portion; and
an undercut radius at the intersection of the web portion and the second foot portion.

11. An air bearing air cycle machine comprising:
a tie rod arranged about a central axis;
a fan rotor comprising:
a root portion arranged radially around the tie rod and having an inner radius between 0.6896 and 0.6922 centimeters, the root portion including:
a first foot portion comprising an annular structure extending longitudinally in a first longitudinal direction from the web portion; and
a second foot portion comprising an annular structure extending longitudinally in a second longitudinal direction from the web portion wherein the second longitudinal direction is opposite the first longitudinal direction;
a web portion extending radially from the root portion, the web portion having a minimum longitudinal thickness between 0.5080 and 0.5334 centimeters; and
a blade portion extending radially from the web portion;
a fan ring arranged radially outward of the first foot portion; and
a seal shaft arranged radially outward of the second portion.

12. The air cycle machine of claim 11, wherein inner radius is between 0.6904 and 0.6914 centimeters.

13. The air cycle machine of claim 11, wherein the minimum longitudinal thickness of the web portion is between 0.5156 and 0.5258 centimeters.

14. The air cycle machine of claim 11, wherein the blade portion extends from the web portion by a blade length, and the blade length is between 7.6149 and 7.6251 centimeters.

15. The air cycle machine of claim 14, wherein the blade length is between 7.6175 and 7.6225 centimeters.

16. The air cycle machine of claim 11, wherein the first foot portion extends from the central axis by a first foot radius, wherein the first foot radius is between 1.379 and 1.380 centimeters.

17. The air cycle machine of claim 16, wherein the first foot radius is between 1.3795 and 1.3800 centimeters.

18. The air cycle machine of claim 11, wherein the second foot portion extends from the central axis by a second foot radius, wherein the second foot radius is between 1.4173 and 1.4183 centimeters.

19. The air cycle machine of claim 18, wherein the second foot radius is between 1.4176 and 1.4181 centimeters.

20. The air cycle machine of claim 11, wherein the root portion further comprises:
a first radiused undercut defined between the first foot portion and the web portion; and
a second radiused undercut defined between the second foot portion and the web portion.
